(19) United States
(12) Patent Application Publication
(10) Pub. No.: US 2025/0010879 A1
(43) Pub. Date: Jan. 9, 2025

(54) SYSTEMS AND METHODS FOR AUTONOMOUS DRIVING USING TRACKING TAGS

(71) Applicant: TORC Robotics, Inc., Blacksburg, VA (US)

(72) Inventors: Akshay Pai RAIKAR, Blacksburg, VA (US); Joseph FOX-RABINOVITZ, Austin, TX (US)

(73) Assignee: TORC Robotics, Inc., Blacksburg, VA (US)

(21) Appl. No.: 18/219,605

(22) Filed: Jul. 7, 2023

(51) Int. Cl. B60W 60/00; G05D 1/02

(52) U.S. Cl. CPC B60W 60/001; B60W 2552/53; B60W 2555/60; B60W 2556/50

(57) ABSTRACT

An autonomous vehicle comprises a sensor and one or more processors. The processors can be configured to monitor, using the sensor, a surface of a road while the autonomous vehicle is driving on the road; detect a numerical identification of a tracking tag embedded underneath a surface of the road based on data collected from the sensor during the monitoring of the surface; query a database using the numerical identification of the tracking tag, the database comprising navigational information corresponding to different numerical identifications of tracking tags; identify first navigational information from the database that corresponds to the detected numerical identification of the tracking tag embedded underneath the surface of the road; determine a navigational action based on the first navigational information; and operate the autonomous vehicle according to the navigational action.

### TECHNICAL FIELD

The present disclosure relates generally to vehicles and, more specifically, to systems and methods for autonomous driving using tracking tags.

### BACKGROUND

The use of autonomous vehicles has become increasingly prevalent in recent years, with the potential for numerous benefits, such as improved safety, reduced traffic congestion, and increased mobility for people with disabilities. Due to the technical nature of the autonomous vehicles, various improvements can be made to roadway systems for the benefit of navigation and decision making by the autonomous vehicles. However, with the deployment of autonomous vehicles on public roads, there is a need to provide these improvements without disruption to non-autonomous vehicles that share the public roads.

### SUMMARY

Roadway systems across the world experience events that cause changes to the conditions of the road. These events may include man generated events, such as construction, nature-based events, such as hurricanes and tornadoes, and/or other events that may change one or more aspects associated with a road. Due to these events, roadway markers (e.g., navigational information about a roadway) may become inaccurate. In some cases, the markers may be missing or may no longer pertain to the environment of the roadway. In some examples, inaccuracies in navigational information may be caused by something other than the events (e.g., the markers were never placed). The inaccuracies may result in impairment to the decision process of a driver or autonomous vehicle, an inability to accurately determine a next step to perform while driving, and an inefficient roadway system, among other deficiencies.

An automated (e.g., autonomous) vehicle system implementing the systems and methods described herein may overcome the aforementioned technical deficiencies. For example, a computer of the autonomous vehicle system may operate to detect a numerical identification of a tracking tag embedded underneath a surface of a road based on data collected from a sensor of the autonomous vehicle. The autonomous vehicle may query a database using the numerical identification of the tracking tag, the database including navigational information corresponding to different numerical identifications of tracking tags. The autonomous vehicle may identify first navigational information from the database that corresponds to the detected numerical identification of the tracking tag embedded underneath the surface of the road. The autonomous vehicle may determine and operate the autonomous vehicle according to a navigational action based on the first navigational information.

To detect the numerical identification of the tracking tag, the computer may monitor, using the sensor of the autonomous vehicle, the surface of the road while the autonomous vehicle is driving on the road. The computer may transmit, via the sensor, a signal (e.g., a pulse) towards the road. The computer may listen for a response signal. If the signal is received by the tracking tag, the tracking tag can send the response signal that includes the numerical identification of the tracking tag. In some examples, the computer may monitor the road for reflective invisible markings (e.g., markings that are of the non-visible spectrum). Based on a reflection of the invisible markings, the computer may determine the numerical identification or other identifying information for determining the navigational action.

The computer may determine the navigational action based on the navigational information. For example, the navigational information may indicate the navigational action or may include a rule. The navigational information may indicate a velocity to move at, a direction to go, a lane to be in, or another type of navigational command for the autonomous vehicle to perform. The navigational information may include a rule such as a speed limit, yield, stop, or detour, among other rules (e.g., any information included in a road sign). Based on the rule, the computer may determine a velocity, a direction, or other navigational action to perform to adhere to the rule.

Advantageously, by performing the methods or adopting the systems as described herein, roadways can include information that is unconditional to being connected to a network, is invisible to a human operator on the roadway, is resistant to harmful events, and is updateable to conform to changes caused by events. For example, the database may be uploaded to the autonomous vehicle for local querying while disconnected from a network. The database may be updateable to map the numerical identification to second navigational information based on changes to the conditions of the roadway. The embedded tracking tag may increase the robustness of the tracking tag against distortions of the road surface.

While the examples described herein are described in the context of autonomous vehicles, any vehicle with a computer that can detect the tracking tags may utilize the systems and methods as described herein.

In at least one aspect, the present disclosure describes an autonomous vehicle. The autonomous vehicle can include one or more sensors and one or more processors coupled with the one or more sensors. The one or more processors can be configured to monitor, using the sensor, a surface of a road while the autonomous vehicle is driving on the road; detect a numerical identification of a tracking tag embedded underneath a surface of the road based on data collected from the sensor during the monitoring of the surface; query a database using the numerical identification of the tracking tag, the database comprising navigational information corresponding to different numerical identifications of tracking tags; identify first navigational information from the database that corresponds to the detected numerical identification of the tracking tag embedded underneath the surface of the road; determine a navigational action based on the first navigational information; and operate the autonomous vehicle according to the navigational action.

In another aspect, the present disclosure describes a method. The method can include monitoring, by one or more processors via a sensor, a surface of a road while an autonomous vehicle is driving on the road; detecting, by the one or more processors, a numerical identification of a tracking tag embedded underneath a surface of the road based on data collected from the sensor during the monitoring of the surface; querying, by the one or more processors, a database using the numerical identification of the tracking tag, the database comprising navigational information corresponding to different numerical identifications of tracking tags; identifying, by the one or more processors, first navigational information from the database that corresponds to the detected numerical identification of the tracking tag embedded underneath the surface of the road; determining, by the one or more processors, a navigational action based on the first navigational information; and operating, by the one or more processors, the autonomous vehicle according to the navigational action.

In another aspect, the present disclosure describes a controller. The controller can include one or more processors configured to monitor, using a sensor, a surface of a road while a vehicle is driving on the road; detect a marking on the road that reflects outside of a visible spectrum based on data collected from the sensor during the monitoring of the surface; decode a numerical identification from the marking based on the data collected from the sensor; query a database using the numerical identification of the marking, the database comprising navigational information that correspond to different numerical identifications of markings; identify a first navigational information from the database that corresponds to the numerical identification of the marking on the road; determine a navigational action based on the first navigational information; and operate the vehicle according to the navigational command.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a bird's-eye view of a roadway including a schematic representation of a vehicle and aspects of an autonomy system of the vehicle, according to an embodiment.

FIG. 2 is a schematic of an autonomy system of a vehicle, according to an embodiment.

FIG. 3 is a bird's-eye view of a roadway that supports detecting a tracking tag by an autonomous vehicle, according to an embodiment.

FIG. 4 is a method for detecting a tracking tag by an autonomous vehicle, according to embodiments.

### DETAILED DESCRIPTION

The following detailed description describes various features and functions of the disclosed systems and methods with reference to the accompanying figures. In the figures, similar components are identified using similar symbols, unless otherwise contextually dictated. The exemplary system(s) and method(s) described herein are not limiting and it may be readily understood that certain aspects of the disclosed systems and methods can be variously arranged and combined, all of which arrangements and combinations are contemplated by this disclosure.

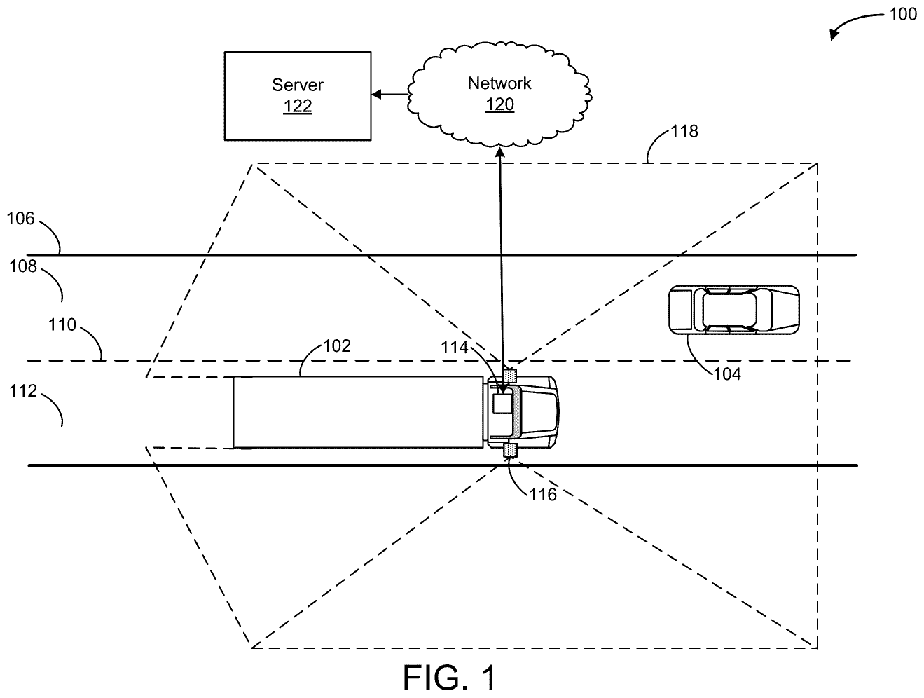

Referring to FIG. 1, the present disclosure relates to autonomous vehicles, such as an autonomous vehicle 102 having an autonomy system 114. The autonomy system 114 of the vehicle 102 may be completely autonomous (fully autonomous) or semi-autonomous. In one example, the autonomous system 114 can operate under Level 5 autonomy (e.g., full driving automation), Level 4 autonomy (e.g., high driving automation), or Level 3 autonomy (e.g., conditional driving automation) . . . . As used herein the term “autonomous” includes both fully autonomous and semi-autonomous. The present disclosure sometimes refers to autonomous vehicles as ego vehicles. The autonomy system 114 may be structured on at least three aspects of technology: (1) perception, (2) maps/localization, and (3) behaviors planning and control. The function of the perception aspect is to sense an environment surrounding the vehicle 102 and interpret the environment. To interpret the surrounding environment, a perception module 116 or engine in the autonomy system 114 of the vehicle 102 may identify and classify objects or groups of objects in the environment. For example, a perception module 116 may be associated with various sensors (e.g., light detection and ranging (LiDAR), camera, radar, etc.) of the autonomy system 114 and may identify one or more objects (e.g., pedestrians, vehicles, debris, etc.) and features of the roadway (e.g., lane lines) around the vehicle 102, and classify the objects in the road distinctly.

The maps/localization aspect of the autonomy system 114 may be configured to determine where on a pre-established digital map the vehicle 102 is currently located. One way to do this is to sense the environment surrounding the vehicle 102 (e.g., via the perception module 116), such as by detecting vehicles (e.g., a vehicle 104) or other objects (e.g., traffic lights, speed limit signs, pedestrians, signs, road markers, energy supply stations, etc.) from data collected via the sensors of the autonomy system 114, and to correlate features of the sensed environment with details (e.g., digital representations of the features of the sensed environment) on the digital map.

Once the systems on the vehicle 102 have determined the location of the vehicle 102 with respect to the digital map features (e.g., location on the roadway, upcoming intersections, road signs, etc.), the vehicle 102 can plan and execute maneuvers and/or routes with respect to the features of the digital map. The behaviors, planning, and control aspects of the autonomy system 114 may be configured to make decisions about how the vehicle 102 should move through the environment to get to the goal or destination of the vehicle 102. The autonomy system 114 may consume information from the perception and maps/localization modules to know where the vehicle 102 is relative to the surrounding environment and what other objects and traffic actors are doing.

FIG. 1 further illustrates an environment 100 for modifying one or more actions of the vehicle 102 using the autonomy system 114. The vehicle 102 is capable of communicatively coupling to a remote server 122 via a network 120. The vehicle 102 may not necessarily connect with the network 120 or the server 122 while it is in operation (e.g., driving down the roadway). That is, the server 122 may be remote from the vehicle, and the vehicle 102 may deploy with all the necessary perception, localization, and vehicle control software and data necessary to complete the vehicle 102's mission fully autonomously or semi-autonomously.

While this disclosure refers to a vehicle 102 as the autonomous vehicle, it is understood that the vehicle 102 could be any type of vehicle including a truck (e.g., a tractor trailer), an automobile, a mobile industrial machine, etc. While the disclosure will discuss a self-driving or driverless autonomous system, it is understood that the autonomous system could alternatively be semi-autonomous having varying degrees of autonomy or autonomous functionality. While the perception module 116 is depicted as being located at the front of the vehicle 102, the perception module 116 may be a part of a perception system with various sensors placed at different locations throughout the vehicle 102 (e.g., a front side of the vehicle 102, an energy input side of the vehicle).

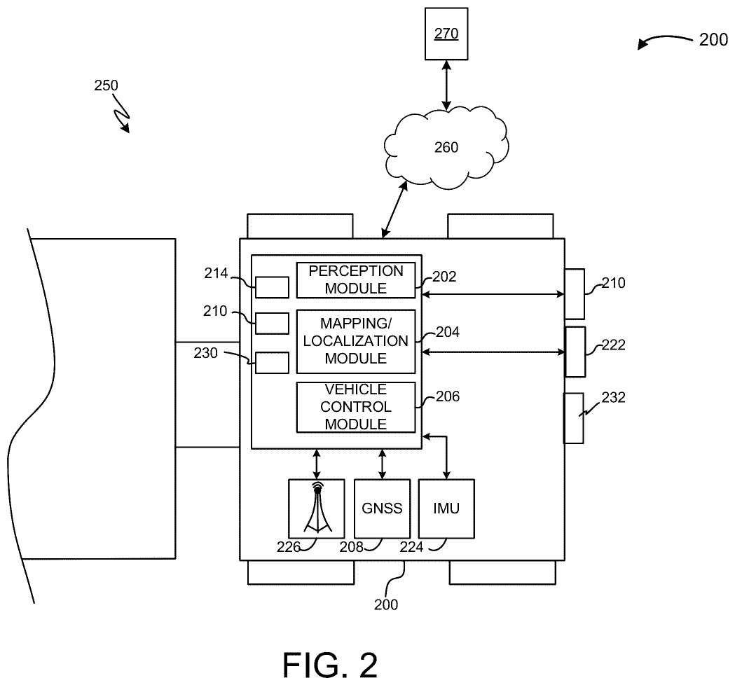

FIG. 2 illustrates an example schematic of an autonomy system 250 of a vehicle 200, according to some embodiments. The autonomy system 250 may be the same as or similar to the autonomy system 114. The vehicle 200 may be the same as or similar to the vehicle 102. The autonomy system 250 may include a perception system including a camera system 220, a LiDAR system 222, a radar system 232, a Global Navigation Satellite System (GNSS) receiver 208, an inertial measurement unit (IMU) 224, and/or a perception module 202. The autonomy system 250 may further include a transceiver 226, a processor 210, a memory 214, a mapping/localization module 204, and a vehicle control module 206. The various systems may serve as inputs to and receive outputs from various other components of the autonomy system 250. In other examples, the autonomy system 250 may include more, fewer, or different components or systems, and each of the components or system(s) may include more, fewer, or different components. Additionally, the systems and components shown may be combined or divided in various ways. As shown in FIG. 1, the perception systems aboard the autonomous vehicle may help the vehicle 102 perceive the vehicle 102's environment out to a perception area 118. The actions of the vehicle 102 may depend on the extent of the perception area 118. It is to be understood that the perception area 118 is an example area, and the practical area may be greater than or less than what is depicted.

The camera system 220 of the perception system may include one or more cameras mounted at any location on the vehicle 102, which may be configured to capture images of the environment surrounding the vehicle 102 in any aspect or field of view (FOV). The FOV can have any angle or aspect such that images of the areas ahead of, to the side, and behind the vehicle 102 may be captured. In some embodiments, the FOV may be limited to particular areas around the vehicle 102 (e.g., forward of the vehicle 102, at the side of the vehicle 102) or may surround 360 degrees of the vehicle 102. In some embodiments, the image data generated by the camera system(s) 220 may be sent to the perception module 202 and stored, for example, in memory 214.

The LiDAR system 222 may include a laser generator and a detector and can send and receive LiDAR signals. A LiDAR signal can be emitted to and received from any direction such that LiDAR point clouds (or “LiDAR images”) of the areas ahead of, to the side, and behind the vehicle 200 can be captured and stored as LiDAR point clouds. In some embodiments, the vehicle 200 may include multiple LiDAR systems and point cloud data from the multiple systems may be stitched together.

The radar system 232 may estimate strength or effective mass of an object, as objects made out of paper or plastic may be weakly detected. The radar system 232 may be based on 24 GHz, 77 GHZ, or other frequency radio waves. The radar system 232 may include short-range radar (SRR), mid-range radar (MRR), or long-range radar (LRR). One or more sensors may emit radio waves, and a processor may process received reflected data (e.g., raw radar sensor data) from the emitted radio waves.

In some embodiments, the system inputs from the camera system 220, the LiDAR system 222, and the radar system 232 may be fused (e.g., in the perception module 202). The LiDAR system 222 may include one or more actuators to modify a position and/or orientation of the LiDAR system 222 or components thereof. The LiDAR system 222 may be configured to use ultraviolet (UV), visible, or infrared light to image objects and can be used with a wide range of targets. In some embodiments, the LiDAR system 222 can be used to map physical features of an object with high resolution (e.g., using a narrow laser beam). In some examples, the LiDAR system 222 may generate a point cloud and the point cloud may be rendered to visualize the environment surrounding the vehicle 200 (or object(s) therein). In some embodiments, the point cloud may be rendered as one or more polygon(s) or mesh model(s) through, for example, surface reconstruction. Collectively, the radar system 232, the LiDAR system 222, and the camera system 220 may be referred to herein as “imaging systems.”

The GNSS receiver 208 may be positioned on the vehicle 200 and may be configured to determine a location of the vehicle 200 via GNSS data, as described herein. The GNSS receiver 208 may be configured to receive one or more signals from a global navigation satellite system (GNSS) (e.g., a GPS) to localize the vehicle 200 via geolocation. The GNSS receiver 208 may provide an input to and otherwise communicate with the mapping/localization module 204 to, for example, provide location data for use with one or more digital maps, such as an HD map (e.g., in a vector layer, in a raster layer or other semantic map, etc.). In some embodiments, the GNSS receiver 208 may be configured to receive updates from an external network.

The IMU 224 may be an electronic device that measures and reports one or more features regarding the motion of the vehicle 200. For example, the IMU 224 may measure a velocity, acceleration, angular rate, and/or an orientation of the vehicle 200 or one or more of the vehicle 200's individual components using a combination of accelerometers, gyroscopes, and/or magnetometers. The IMU 224 may detect linear acceleration using one or more accelerometers and rotational rate using one or more gyroscopes. In some embodiments, the IMU 224 may be communicatively coupled to the GNSS receiver 208 and/or the mapping/localization module 204 to help determine a real-time location of the vehicle 200 and predict a location of the vehicle 200 even when the GNSS receiver 208 cannot receive satellite signals.

The transceiver 226 may be configured to communicate with one or more external networks 260 via, for example, a wired or wireless connection in order to send and receive information (e.g., to a remote server 270). The wireless connection may be a wireless communication signal (e.g., Wi-Fi, cellular, LTE, 5G, etc.). In some embodiments, the transceiver 226 may be configured to communicate with external network(s) via a wired connection, such as, for example, during initial installation, testing, or service of the autonomy system 250 of the vehicle 200. A wired/wireless connection may be used to download and install various lines of code in the form of digital files (e.g., HD digital maps), executable programs (e.g., navigation programs), and other computer-readable code that may be used by the system 250 to navigate the vehicle 200 or otherwise operate the vehicle 200, either fully autonomously or semi-autonomously.

The processor 210 of autonomy system 250 may be embodied as one or more of a data processor, a microcontroller, a microprocessor, a digital signal processor, a logic circuit, a programmable logic array, or one or more other devices for controlling the autonomy system 250 in response to one or more of the system inputs. The autonomy system 250 may include a single microprocessor or multiple microprocessors that may include means for controlling the vehicle 200 to move (e.g., switch lanes) and monitoring and detecting other vehicles. Numerous commercially available microprocessors can be configured to perform the functions of the autonomy system 250. It should be appreciated that the autonomy system 250 could include a general machine controller capable of controlling numerous other machine functions. Alternatively, a special-purpose machine controller could be provided. Further, the autonomy system 250, or portions thereof, may be located remote from the system 250. For example, one or more features of the mapping/localization module 204 could be located remote to the vehicle 200. Various other known circuits may be associated with the autonomy system 250, including signal-conditioning circuitry, communication circuitry, actuation circuitry, and other appropriate circuitry.

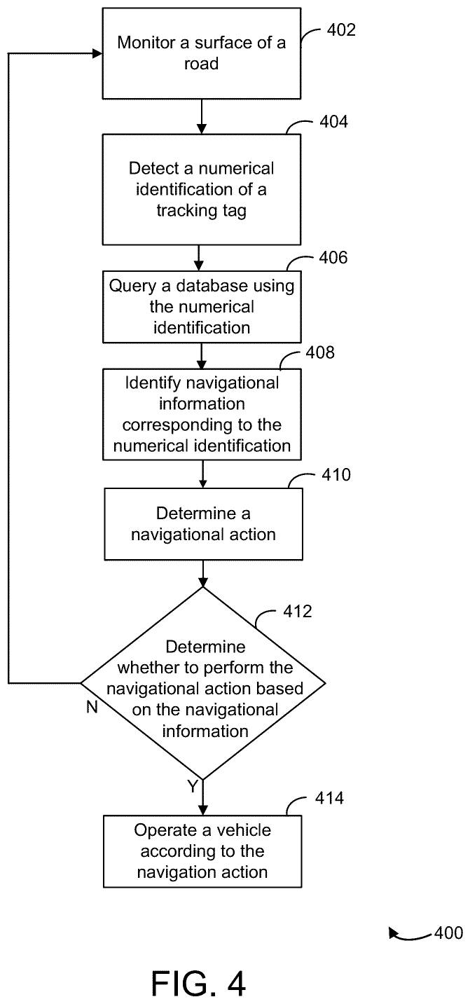

The memory 214 of the autonomy system 250 may store data and/or software routines that may assist the autonomy system 250 in performing autonomy system 250's functions, such as the functions of the perception module 202, the mapping/localization module 204, the vehicle control module 206, a tracking tag detection module 230, and the method 400 described herein with respect to FIG. 4. Further, the memory 214 may also store data received from various inputs associated with the autonomy system 250, such as perception data from the perception system.

As noted above, the perception module 202 may receive input from the various sensors, such as the camera system 220, the LiDAR system 222, the GNSS receiver 208, and/or the IMU 224 (collectively “perception data”) to sense an environment surrounding the vehicle 200 and interpret it. To interpret the surrounding environment, the perception module 202 (or “perception engine”) may identify and classify objects or groups of objects in the environment. For example, the vehicle 102 may use the perception module 202 to identify one or more objects (e.g., pedestrians, vehicles, debris, etc.) or features of the roadway 106 (e.g., intersections, road signs, lane lines, etc.) before or beside a vehicle and classify the objects in the road. In some embodiments, the perception module 202 may include an image classification function and/or a computer vision function.

The system 250 may collect perception data. The perception data may represent the perceived environment surrounding the vehicle, for example, and may be collected using aspects of the perception system described herein. The perception data can come from, for example, one or more of the LiDAR system, the camera system, the radar system and various other externally-facing sensors and systems on board the vehicle (e.g., the GNSS receiver, etc.). For example, in vehicles having a sonar or radar system, the sonar and/or radar systems may collect perception data. As the vehicle 102 travels along the roadway 106, the system 250 may continually receive data from the various systems on the vehicle 102. In some embodiments, the system 250 may receive data periodically and/or continuously. With respect to FIG. 1, the vehicle 102 may collect perception data that indicates the presence of the lane line 110 (e.g., in order to determine the lanes 108 and 112). Additionally, the detection systems may detect the vehicle 104 and monitor the vehicle 104 to estimate various properties of the vehicle 104 (e.g., proximity, speed, behavior, flashing light, etc.). The properties of the vehicle 104 may be stored as timeseries data in which timestamps indicate the times in which the different properties were measured or determined. The features may be stored as points (e.g., vehicles, signs, small landmarks, etc.), lines (e.g., lane lines, road edges, etc.), or polygons (e.g., lakes, large landmarks, etc.) and may have various properties (e.g., style, visible range, refresh rate, etc.), which properties may control how the system 250 interacts with the various features.

The image classification function may determine the features of an image (e.g., a visual image from the camera system 220 and/or a point cloud from the LiDAR system 222). The image classification function can be any combination of software agents and/or hardware modules able to identify image features and determine attributes of image parameters in order to classify portions, features, or attributes of an image. The image classification function may be embodied by a software module that may be communicatively coupled to a repository of images or image data (e.g., visual data and/or point cloud data) which may be used to determine objects and/or features in real-time image data captured by, for example, the camera system 220 and the LiDAR system 222. In some embodiments, the image classification function may be configured to classify features based on information received from only a portion of the multiple available sources. For example, in the case that the captured visual camera data includes images that may be blurred, the system 250 may identify objects based on data from one or more of the other systems (e.g., the LiDAR system 222) that does not include the image data.

The computer vision function may be configured to process and analyze images captured by the camera system 220 and/or the LiDAR system 222 or stored on one or more modules of the autonomy system 250 (e.g., in the memory 214), to identify objects and/or features in the environment surrounding the vehicle 200 (e.g., lane lines). The computer vision function may use, for example, an object recognition algorithm, video tracing, one or more photogrammetric range imaging techniques (e.g., a structure from motion (SfM) algorithms), or other computer vision techniques. The computer vision function may be configured to, for example, perform environmental mapping and/or track object vectors (e.g., speed and direction). In some embodiments, objects or features may be classified into various object classes using the image classification function, for instance, and the computer vision function may track the one or more classified objects to determine aspects of the classified object (e.g., aspects of the vehicle 200's motion, size, etc.)

The mapping/localization module 204 receives perception data that can be compared to one or more digital maps stored in the mapping/localization module 204 to determine where the vehicle 200 is in the world and/or where the vehicle 200 is on the digital map(s). In particular, the mapping/localization module 204 may receive perception data from the perception module 202 and/or from the various sensors sensing the environment surrounding the vehicle 200 and correlate features of the sensed environment with details (e.g., digital representations of the features of the sensed environment) on the one or more digital maps. The digital map may have various levels of detail and can be, for example, a raster map, a vector map, etc. The digital maps may be stored locally on the vehicle 200 and/or stored and accessed remotely.

The vehicle control module 206 may control the behavior and maneuvers of the vehicle 200. For example, once the systems on the vehicle 200 have determined the vehicle 200's location with respect to map features (e.g., intersections, road signs, lane lines, etc.) the vehicle 200 may use the vehicle control module 206 and the vehicle 200's associated systems to plan and execute maneuvers and/or routes with respect to the features of the environment. The vehicle control module 206 may make decisions about how the vehicle 200 will move through the environment to get to the vehicle 200's goal or destination as it completes the vehicle 200's mission. The vehicle control module 206 may consume information from the perception module 202 and the mapping/localization module 204 to know where it is relative to the surrounding environment and what other traffic actors are doing.

The vehicle control module 206 may be communicatively and operatively coupled to a plurality of vehicle operating systems and may execute one or more control signals and/or schemes to control operation of the one or more operating systems, for example, the vehicle control module 206 may control one or more of a vehicle steering system, a propulsion system, and/or a braking system. The propulsion system may be configured to provide powered motion for the vehicle 200 and may include, for example, an engine/motor, an energy source, a transmission, and wheels/tires and may be coupled to and receive a signal from a throttle system, for example, which may be any combination of mechanisms configured to control the operating speed and acceleration of the engine/motor and thus, the speed/acceleration of the vehicle 200. The steering system may be any combination of mechanisms configured to adjust the heading or direction of the vehicle 200. The brake system may be, for example, any combination of mechanisms configured to decelerate the vehicle 200 (e.g., friction braking system, regenerative braking system, etc.) The vehicle control module 206 may be configured to avoid obstacles in the environment surrounding the vehicle 200 and may be configured to use one or more system inputs to identify, evaluate, and modify a vehicle trajectory. The vehicle control module 206 is depicted as a single module, but can be any combination of software agents and/or hardware modules able to generate vehicle control signals operative to monitor systems and control various vehicle actuators. The vehicle control module 206 may include a steering controller for vehicle lateral motion control and a propulsion and braking controller for vehicle longitudinal motion.

The tracking tag detection module 230 may monitor, via the perception module 202, a surface of a road while the vehicle 102 is driving on the road. The tracking tag detection module 230 may communicate with the perception module 202 to collect data from a sensor (e.g., a non-visible camera, a receiver, a radio frequency identification (RFID) reader) of the perception module 202 monitoring the surface. The sensor may detect an electronic tracking (e.g., RFID, low frequency (LF), high frequency (HF), ultra-high frequency (UHF), near field communication (NFC), etc.) tag embedded underneath the surface of the road. For example, the sensor may output (e.g., transmit) a signal (e.g., a pulse, a radio wave) towards the road. A tracking tag embedded in the road may receive the signal and transmit a second signal to the sensor. In some cases, the tracking tag is a passive tag. For example, the radio wave may provide the tracking tag with sufficient energy to transmit the second signal a first distance. In some cases, the tracking tag is an active tag. For example, the tracking tag (e.g., an active RFID tag, a Wi-Fi hotspot, an emitter) may include a battery that support transmission of the second signal a second distance greater than the first distance. The active tag may also provide other services such as internet access in addition to navigational and guidance information.

Responsive to detecting the electronic tracking tag, the perception module 202 may detect a numerical identification of the tracking tag. For example, the second signal may include the numerical identification. Each tracking tag may be associated with a different numerical identification (e.g., a unique identification number). The tracking tag detection module 230 may query a database (the memory 214) using the numerical identification. The database may include a map of numerical identifications corresponding to navigational information. The navigational information may indicate a navigational action or a rule. In some cases, the navigational information may indicate a car operation, such as a specific lamp (e.g., break light or turn light) to activate, honk a horn, or to activate a turn signal. Based on the navigational action or the car operation, the tracking tag detection module 230 may communicate with the perception module 202, the mapping/localization module 204, and the vehicle control module 206 to operate the vehicle 102 according to the navigational action or car operation. If the navigational information indicates the rule, the tracking tag detection module 230 can determine the navigational action based on the rule. For example, the rule may be a speed limit. The tracking tag detection module 230 can communicate with the perception module 202, the mapping/localization module 204, and the vehicle control module 206 to operate the vehicle 102 to maintain a velocity below the speed limit.

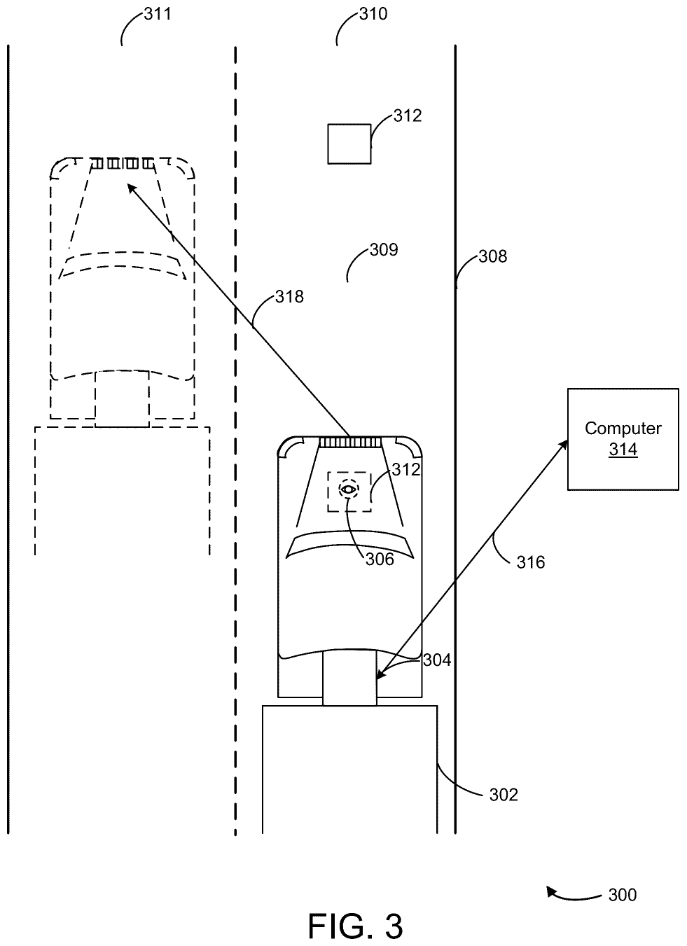

FIG. 3 is a bird's-eye view of a roadway that supports detecting a tracking tag by a vehicle, according to an embodiment. FIG. 3 illustrates an environment 300 that includes a vehicle 302, a roadway 308, and a remote computer 314. The vehicle 302 can include one or more sensors 306 and an autonomy system 304. The vehicle 302 can be the same as or similar to the vehicles 102 and 200. The roadway 308 can include a first lane 310, a second lane 311, and one or more tracking tags 312. The vehicle 302 can be in wireless communication with the remote computer 314 via a wireless channel 316.

In some cases, the vehicle 302 may be driving in the first lane 310 of the roadway 308. While driving, the vehicle 302 may monitor, using the sensors 306, a surface 309 of the first lane 310. The vehicle may monitor the surface 309 by transmitting a signal towards the surface 309. In some cases, the vehicle 302 contiguously transmits the signal. In some cases, the vehicle transmits the signal periodically (e.g., after a configured distance, after a configured period of time) or aperiodically (e.g., in response to an event). The sensors 306 may include non-visible cameras, RFID readers, receivers, or radio wave transmitters, among other sensors that can detect tracking tags.

While monitoring the surface 309, the vehicle 302 may detect a tracking tag 312. For example, the vehicle 302 may receive a second signal from the tracking tag 312 in response to the signal transmitted by the sensors 306. The second signal may include data associated with the tracking tag 312. The data may include an identification number of the tracking tag. The identification number may be a unique identification number among tracking tags. For example, multiple roadways 308 may include tracking tags 312. If there are approximately four million miles of paved road in the United States, 26 bits (8 decimal bits) of information may be sufficient to distinguish tracking tags 312 from each other, for example, if placed at every 1/10^{th} of a mile across the four million miles of paved road. Each tracking tag 312 of all of the roadways 308 may be associated with a unique identification number to distinguish one from another. The tracking tag 312 may be embedded underneath the surface 309 (e.g., sufficiently deep to not be damaged). For example, the tracking tag 312 may be located at a distance below the surface 309 based on a signal strength of the tracking tag 312. In some cases, the tracking tag 312 may be located on top of the surface 309. The surface 309 may include a first vertical portion of the roadway 308 (e.g., an asphalt portion) such that the tracking tag 312 is embedded below the first vertical portion. In some cases, the tracking tag 312 may be a reflective marking (e.g., a reflective marking on the surface 309) that is reflective in the non-visible spectrum. For example, the marking may reflect light at a wavelength that is not perceptible by the human eye. The mark may indicate the identification number or other information (e.g., navigational information).

The vehicle 302 may query a database using the identification number received from the tracking tag 312. In some cases, the database may be a local database stored in memory of the autonomy system 304. The database may be a remote database stored in memory of the remote computer 314 or in a cloud environment. The database may be partially stored in any combination of the local database, the remote computer 314, or the cloud environment. In some embodiments, the vehicle 302 may send a first message including the query to the local database and obtain a response message from the local database. The vehicle 302 may transmit the first message including the query via the wireless channel 316 to the remote computer 314 and receive a response message from the remote computer 314. The query may include the identification number. The database may include a mapping of identification numbers to navigational information. For example, the database may include an entry for each identification number of each tracking tag 312. Each identification number may correspond to respective navigational information.

The vehicle 302 may obtain (e.g., via the second message from the local database, from the remote computer 314) the navigational information associated with the identification number of the tracking tag 312. The navigational information may indicate a navigational action, a rule, or other navigational information associated with the roadway 308. For example, the navigational information may indicate any roadway information included in road or traffic signs (e.g., a mile marker, a yield sign, an address). The rule may be a speed limit, or other rule associated with the roadway 308. In some cases, the navigational information indicates a location (e.g., GPS coordinates) of the tracking tag 312.

The vehicle 302 may perform the navigational action. For example, the navigational action may be to merge the vehicle 302 into another lane. The vehicle 302 may move a direction 318 to merge into the second lane 311. In some cases, the navigational action may be to maintain a speed or perform another type of action associated with navigating the vehicle 302 along a current route. For example, the vehicle 302 may be moving towards a destination on the current route. The vehicle 302 may detect a tracking tag 312 at a location on the roadway 308. The vehicle 302 may obtain an identification number from the tracking tag 312 indicating a mile marker of the roadway 308. Based on determining the mile marker, the vehicle 302 may identify a navigational action to merge the vehicle 302 into another lane and reduce the speed of the vehicle 302 (e.g., in preparation to exit a freeway or turn onto another roadway) in accordance with moving towards the destination.

In some cases, the database may be updated. For example, distortions of the roadway 308 (e.g., movement of the road, earthquakes, continental drift, construction) or changes to road signs or marks may cause the navigational information to become outdated (e.g., erroneous, wrong, abnormal). The vehicle 302 may periodically, or in response to an event, update the database (e.g., a local database) based on a master database of the remote computer 314. For example, the vehicle 302 may transmit a request to the remote computer 314 to update the database stored at the vehicle 302. In response, the remote computer 314 may send a message including a current copy of the master database to the vehicle 302. In some cases, the message may only include portions of the database (e.g., only include the updates to the master database). Multiple methods of sending information and updating the database can be utilized by the systems described herein. In this way, the remote computer 314 and the vehicle 302 can synchronize the databases stored therein.

FIG. 4 shows execution steps of a processor-based method using the system 250, according to some embodiments. The method 400 shown in FIG. 4 comprises execution steps 402-412. However, it should be appreciated that other embodiments may comprise additional or alternative execution steps, or may omit one or more steps altogether. It should also be appreciated that other embodiments may perform certain execution steps in a different order. Steps discussed herein may also be performed simultaneously or near-simultaneously.

FIG. 4 is described as being performed by a data processing system stored on or otherwise located at an autonomous vehicle, such as the autonomous vehicle 302 depicted in FIG. 3. However, in some embodiments, one or more of the steps may be performed by a different processor, server, or any other computing feature. For instance, one or more of the steps may be performed via a cloud-based service or another processor in communication with the processor of an autonomous vehicle and/or the autonomy system of such an autonomous vehicle.

At 402, the data processing system monitors a surface of a road. The data processing system may monitor the surface of the road using a sensor of the autonomous vehicle while the autonomous vehicle is driving on the road. At 404, the data processing system detects a numerical identification of a tracking tag embedded underneath the surface of the road. The tracking tag may transmit data indicating the numerical identification responsive to receiving a signal (e.g., a pulse) from the sensor of the autonomous vehicle. The numerical identification may be unique to the tracking tag. The tracking tag may be an RFID tag and the sensor may be an RFID reader.

At 406, the data processing system queries a database using the numerical identification of the tracking tag. The database may include navigational information corresponding to different numerical identifications of tracking tags. For example, multiple tracking tags may be embedded at different locations. Each tracking tag may be associated with a unique numerical identification. The database may include a row for each numerical identification that corresponds to navigational information.

At 408, the data processing system identifies first navigational information from the database that corresponds to the detected numerical identification of the tracking tag embedded underneath the surface of the road. At 410, the data processing system determines a navigational action based on the first navigational information. In some cases, the first navigational information indicated the navigational information. In some cases, the first navigational information includes a rule, where the determination of the navigational action is based on the rule. In some cases, the rule is a speed limit associated with the road and the navigational action is to maintain a speed based on the speed limit. At 412, the data processing system determines whether to perform the navigational action based on the navigational information. For example, if the navigational information includes information that has no affect on a current route of the autonomous vehicle (e.g., an address that is not part of the current route), the autonomous vehicle may continue back to 402. If the data processing system determines to perform the navigational action, at 414, the data processing system operates the autonomous vehicle according to the navigational action.

In some cases, the data processing system receives an update to the database. For example, the data processing system may request for an update, receive the update based on a period of time without updating the database ending, or based on a master database being updated. The data processing system may update the database based on the received update. The data processing may perform the method 400 based on the updated database.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various components, blocks, modules, circuits, and steps have been generally described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. An autonomous vehicle, comprising:
a sensor;
one or more processors configured to:
monitor, using the sensor, a surface of a road while the autonomous vehicle is driving on the road;
detect a numerical identification of a tracking tag embedded underneath the surface of the road based on data collected from the sensor during the monitoring of the surface;
query a database using the numerical identification of the tracking tag, the database comprising navigational information corresponding to different numerical identifications of tracking tags;
identify first navigational information from the database that corresponds to the detected numerical identification of the tracking tag embedded underneath the surface of the road;
determine a navigational action based on the first navigational information; and
operate the autonomous vehicle according to the navigational action.

2. The autonomous vehicle of claim 1, wherein the first navigational information indicates the navigational action.

3. The autonomous vehicle of claim 1, wherein the one or more processors operate the autonomous vehicle to turn a defined direction based on performing the navigational action.

4. The autonomous vehicle of claim 1, wherein the one or more processors determine the navigational action based on a rule included in the first navigational information.

5. The autonomous vehicle of claim 4, wherein the rule is a speed limit associated with the road, and the one or more processors operate the autonomous vehicle to maintain a speed based on the speed limit.

6. The autonomous vehicle of claim 1, wherein the sensor is a radio frequency identification (RFID) reader and the tracking tag is an RFID tag.

7. The autonomous vehicle of claim 1, wherein the one or more processors query the database by:
transmitting, to a remote database across a network, a first message comprising the numerical identification; and
receiving, from the remote database across the network, a second message comprising the first navigational information.

8. The autonomous vehicle of claim 1, wherein the one or more processors query the database by:
sending, to a local database of the autonomous vehicle, a first message comprising the numerical information; and
obtaining, from the local database, a second message comprising the first navigational information.

9. The autonomous vehicle of claim 8, wherein the one or more processors are configured to:
receive, from a remote computer across a network, an update associated with the local database; and
update the local database based on the received update.

10. The autonomous vehicle of claim 1, wherein the numerical identification corresponds to a location and the location corresponds to the first navigational information.

11. The autonomous vehicle of claim 1, wherein the one or more processors detect the numerical identification by:
detecting, via the sensor, a second tracking tag; and
adjusting operation of the autonomous vehicle according to a second navigational action.

12. A method, comprising:
monitoring, by one or more processors via a sensor, a surface of a road while an autonomous vehicle is driving on the road;
detecting, by the one or more processors, a numerical identification of a tracking tag embedded underneath a surface of the road based on data collected from the sensor during the monitoring of the surface;
querying, by the one or more processors, a database using the numerical identification of the tracking tag, the database comprising navigational information corresponding to different numerical identifications of tracking tags;
identifying, by the one or more processors, first navigational information from the database that corresponds to the detected numerical identification of the tracking tag embedded underneath the surface of the road;
determining, by the one or more processors, a navigational action based on the first navigational information; and
operating, by the one or more processors, the autonomous vehicle according to the navigational action.

13. The method of claim 12, wherein querying the database comprises:
transmitting, by the one or more processors to a remote database across a network, a first message comprising the numerical identification; and
receiving, by the one or more processors from the remote database across the network, a second message comprising the first navigational information.

14. The method of claim 12, wherein querying the database comprises:
sending, by the one or more processors to a local database of the autonomous vehicle, a first message comprising the numerical information; and
obtaining, by the one or more processors from the local database, a second message comprising the first navigational information.

15. The method of claim 14, further comprising:
receiving, by the one or more processors from a remote computer across a network, an update associated with the local database; and
updating, by the one or more processors, the local database based on the received update.

16. The method of claim 12, wherein the sensor is a radio frequency identification (RFID) reader and the tracking tag is an RFID tag.

17. A controller comprising:
one or more processors, the one or more processors configured to:
monitor, using a sensor, a surface of a road while a vehicle is driving on the road;
detect a marking on the road that reflects outside of a visible spectrum based on data collected from the sensor during the monitoring of the surface;
decode a numerical identification from the marking based on the data collected from the sensor;
query a database using the numerical identification of the marking, the database comprising navigational information that correspond to different numerical identifications of markings;
identify a first navigational information from the database that corresponds to the numerical identification of the marking on the road;
determine a navigational action based on the first navigational information; and
operate the vehicle according to the navigational command.

18. The controller of claim 17, wherein the first navigational information indicates a velocity for the vehicle or a velocity limit for the road.

19. The controller of claim 17, wherein the one or more processors are configured to query by:
transmitting, to a remote database across a network, a first message comprising the numerical identification; and
receiving, from the remote database across the network, a second message comprising the first navigational information.

20. The controller of claim 17, wherein the one or more processors are configured to query by:
sending, to a local database of the autonomous vehicle, a first message comprising the numerical information; and
obtaining, from the local database, a second message comprising the first navigational information.
